(19) United States
(12) Patent Application Publication
(10) Pub. No.: US 2006/0141138 A1
(43) Pub. Date: Jun. 29, 2006

(54) Microwave annealing of membranes for use in fuel cell assemblies

(75) Inventors: Steven J. Hamrock, Stillwater, MN (US); Michael A. Yandrasits, Hastings, MN (US); Adam M. Puhl, Oshkosh, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/243,669

(22) Filed: Oct. 5, 2005

Related U.S. Application Data
(60) Provisional application No. 60/639,905, filed on Dec. 29, 2004.

(51) Int. Cl. B05D 5/12; C08J 5/22; H01M 8/10; B05D 3/02

(52) U.S. Cl. 427/115; 521/27; 427/385.5; 429/30

(57) ABSTRACT

Methods of manufacturing a film involve providing a coating of an ion-containing polymer or ion-containing polymer precursor and annealing the coating to form a film using microwave radiation. Methods of manufacturing an ion-containing membrane for use in a membrane electrode assembly of a fuel cell involve coating a solution of an ion-containing polymer or ion-containing polymer precursor to form a cast membrane of the membrane electrode assembly, and annealing the cast membrane using microwave radiation. The cast membrane may comprise a PEM, for example, which may be incorporated in a fuel cell assembly.

### CROSS-REFERENCE TO RELATED APPLICATION

This application claims the benefit of U.S. Provisional Patent Application No. 60/639,905, filed on Dec. 29, 2004.

### FIELD OF THE INVENTION

This invention relates to microwave annealing a coating of a solution or suspension of an ion-containing polymer or ion-containing polymer precursor, and further relates to microwave annealing a coating of a solution or suspension of an ion-containing polymer or ion-containing polymer precursor to form a membrane of a membrane electrode assembly (MEA).

### BACKGROUND OF THE INVENTION

A typical fuel cell system includes a power section in which one or more fuel cells generate electrical power. A fuel cell is an energy conversion device that converts hydrogen and oxygen into water, producing electricity and heat in the process. Each fuel cell unit may include a proton exchange membrane (PEM) at the center with gas diffusion layers on either side of the PEM. Anode and cathode catalyst layers are respectively positioned at the inside of the gas diffusion layers. This unit is referred to as a membrane electrode assembly (MEA). Separator plates or flow field plates are respectively positioned on the outside of the gas diffusion layers of the membrane electrode assembly. This type of fuel cell is often referred to as a PEM fuel cell.

The reaction in a single MEA in a fuel cell typically produces less than one volt. A plurality of the MEAs may be stacked and electrically connected in series to achieve a desired voltage. Electrical current is collected from the fuel cell stack and used to drive a load. Fuel cells may be used to supply power for a variety of applications, ranging from automobiles to laptop computers.

### SUMMARY OF THE INVENTION

The present invention is directed to methods and apparatuses for manufacturing coatings, films, and membranes comprising an ion-containing polymer or ion-containing polymer precursor subjected to microwave annealing. The present invention is also directed to articles manufactured using coatings, films, and membranes comprising an ion-containing polymer or ion-containing polymer precursor subjected to microwave annealing.

“Microwave annealing” is herein defined as a process of subjecting a coating of a material to microwave radiation. During this process, physical changes may occur in the material such as evaporation of liquid components of the coating or polymer particles which are distinct in the dispersion and which remain distinct in the cast or coated membrane and coalesce to form a continuous solid phase with reduced or preferably obliterated boundaries. Other changes may occur such as changes in the size and number of crystalline phases in a polymer component of the coating or rearrangement of aggregates of the ionic groups of an ion-containing polymer component of the coating.

“Thermal annealing” is herein defined as a process of subjecting a coating of a material to heat (e.g., in an oven). Either microwave annealing or thermal annealing typically improves the physical properties of the coating.

A “coating” is herein defined as a dry or liquid containing layer on a substrate comprising a polymer component. The term “coating” is interchangeable with the term “casting.”

According to an embodiment of the present invention, a method of manufacturing a film involves providing a coating of an ion-containing polymer or ion-containing polymer precursor and microwave annealing the coating to form a film. Microwave annealing the coating may involve subjecting the coating to the microwave radiation for a duration of time sufficient for the coating to reach or exceed a film forming temperature. Microwave annealing the coating may also involve subjecting the coating to microwave radiation that preferentially excites a solvent of the coating or preferentially excites water in the coating. Microwave annealing the coating may involve subjecting the coating to microwave radiation that preferentially excites functional groups of the polymer of the coating.

A method of the present invention may involve providing the coating on a liner, and microwave annealing the coating while on the liner to form a film on the liner. The ion-containing polymer or ion-containing polymer precursor may, for example, comprise an aromatic polymer, a fluoropolymer, a fluoropolymer bearing sulfonate functional groups, or a fluoropolymer derived from a fluoropolymer latex.

In accordance with another embodiment, a method of manufacturing an ion-containing membrane for use in a membrane electrode assembly of a fuel cell involves coating a solution of an ion-containing polymer or ion-containing polymer precursor to form a membrane of the membrane electrode assembly, and microwave annealing the membrane. The membrane may comprise a PEM, for example, which may be incorporated in a fuel cell assembly.

According to a further embodiment, a sub-assembly for use in manufacturing an MEA of a fuel cell may include a membrane comprising an ion-containing polymer and a liner in contact with the membrane. The liner may have an upper use temperature about equal to or less than a film forming temperature associated with the membrane. The membrane may comprise a PEM. The liner may, for example, comprise a polyolefin. By way of further example, the liner may be formed from a polyester, polyethylenenaphthalate, polyimide, or a fluoropolymer. The upper use temperature of the liner typically ranges from about 80° C. to about 300° C.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a flow diagram describing a method of manufacturing a film that involves microwave annealing a coating of an ion-containing polymer or ion-containing polymer precursor in accordance with an embodiment of the present invention;

FIG. 2 is a flow diagram describing a method of manufacturing a film on a liner that involves microwave annealing a coating of an ion-containing polymer or ion-containing polymer precursor in accordance with an embodiment of the present invention;

FIG. 3 illustrates a depiction of an apparatus for manufacturing an ion-containing membrane for use in a membrane electrode assembly of a fuel cell that employs microwave annealing of a cast solution of an ion-containing polymer or ion-containing polymer precursor to form a cast membrane on a liner in accordance with an embodiment of the present invention;

FIG. 4 is graphical representation of comparative puncture test data made on test samples of membranes fabricated using conventional thermal annealing methods and samples of membranes fabricated using microwave annealing in accordance with the present invention;

FIG. 5 is an illustration of a fuel cell and its constituent layers that may incorporate an ion-containing membrane manufactured by use of microwave annealing in accordance with embodiments of the present invention; and

FIG. 6 illustrates a unitized cell assembly having monopolar flow field plates that may incorporate an ion-containing membrane manufactured by use of microwave annealing in accordance with embodiments of the present invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

Aspects of the present invention will generally be described within the context of membranes for fuel cell assemblies. Although manufacturing approaches according to the present invention are particularly advantageous in the context of membrane fabrication for fuel cell assemblies, it will be appreciated that the principles of the present invention may be implemented in a wide variety of applications where coatings, films, or casts of an ion-containing polymer of ion-containing polymer precursor can benefit from microwave annealing to achieve desired properties. Accordingly, the specific illustrative embodiments described below are for purposes of explanation, and not of limitation.

The polymer electrolyte or polymer electrolyte precursor is first cast, coated or otherwise formed from a suspension or solution into a suitable shape, preferably a thin layer. Any suitable method of coating or casting may be used, including but not limited to bar coating, spray coating, slit coating, brush coating, a solvent casting or other formation; a formation that results from extruding a solvent onto a liner or carrier; a formation that results from spraying or otherwise depositing a solvent onto a liner or carrier, and the like.

It is known that membranes fabricated for use in membrane electrode assemblies, for example, may be subjected to thermal annealing at relatively high temperatures. Examples of such methods of membrane fabrication are described in commonly owned U.S. Pat. No. 6,649,295, which is hereby incorporated herein by reference. Although a thermal annealing process produces membranes with good mechanical properties, it has been determined that thermal annealing of membranes is a complex process, and is difficult to scale up due to the high temperatures used, among other reasons.

Microwave annealing of a coated membrane according to the principles of the present invention has been shown to successfully produce membranes with good mechanical properties, including good puncture resistance, that are at least comparable with membranes fabricated using conventional thermal annealing processes. Microwave annealing of coated membranes according to the principles of the present invention provides for a membrane manufacturing process of reduced complexity when compared to thermal annealing, for example. Moreover, microwave annealing of coated membranes according to the present invention can facilitate mass production of such membranes. Further, significant energy savings can be realized by replacing relatively inefficient conventional thermally annealing ovens (that must heat large volumes at specified temperatures) with highly efficient microwave radiation sources. Other embodiments of the invention further comprise combinations of microwave and thermal annealing as well as drying the coating.

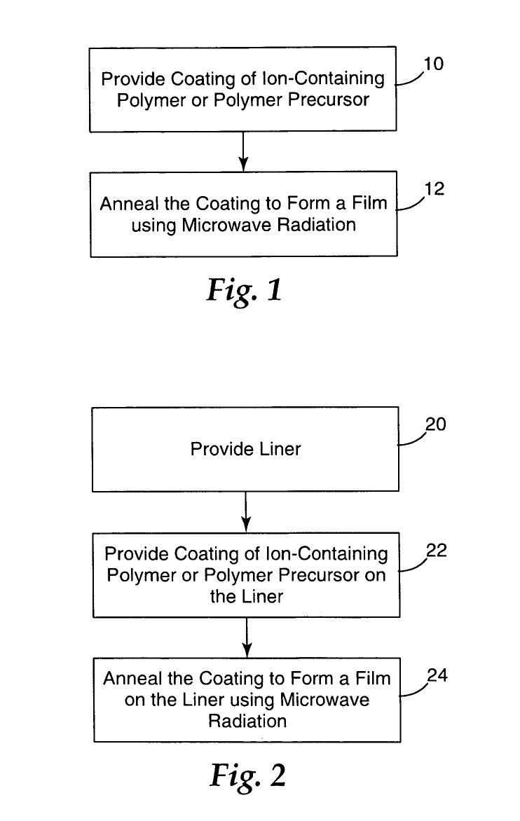

Turning to FIG. 1, there is illustrated a generalized flow diagram that describes a method of manufacturing a film in accordance with an embodiment of the present invention. A method of manufacturing a film according to the approach depicted in FIG. 1 involves providing 10 a coating of an ion-containing polymer or ion-containing polymer precursor. The coating is subject to annealing 12 using microwave radiation. An ion-containing polymer precursor is intended to refer to a polymer comprising groups that can be converted into ionic groups. The term coating is intended to refer to bar coating; spray coating; slit coating; brush coating; a solvent casting or other formation; a formation that results from extruding a solvent onto a liner or carrier; a formation that results from spraying or otherwise depositing a solvent onto a liner or carrier, and the like.

The method of manufacturing a film according to FIG. 1 may further include thermally annealing the ion-containing polymer or ion-containing polymer precursor. The method of manufacturing a film according to FIG. 1 may also include drying the coating.

FIG. 2 is a generalized flow diagram that describes a method of manufacturing a film in accordance with an embodiment of the present invention. According to the method described in FIG. 2, a liner is provided 20 and a coating of an ion-containing polymer or ion-containing polymer precursor is provided 22 on the liner. The coating is subject to microwave annealing 24 to form a film on the liner. A film fabrication approach employing microwave annealing of coatings on liners can be implemented as part of a continuous film manufacturing process or, alternatively, a batch manufacturing process.

Suitable ion-containing polymers or ion-containing polymer precursors that may be subject to microwave annealing for fabricating coatings, films, and membranes in accordance with the present invention include aromatic polymers, fluoropolymers, fluoropolymers bearing sulfonate functional groups, Nafion® (DuPont Chemicals, Wilmington, Del.), and Flemion™ (Asahi Glass Co. Ltd., Tokyo, Japan). These include ion-containing polymers or ion-containing polymer precursors that may comprise: pendant groups according to the formula: YOSO₂—CF₂—CF₂—O—CF(CF₃)CF₂—O-[polymer backbone], where Y is a cation; pendant groups according to the formula: YOSO₂—CF₂—CF₂—CF₂—CF₂—O-[polymer backbone], where Y is a cation; or pendant groups according to the formula: YOSO₂—(CF₂)ₙ—O-[polymer backbone], where each n independently is 2-5. Suitable ion-containing polymers or ion-containing polymer precursors may comprise a fluoropolymer derived from a fluoropolymer latex.

Suitable ion-containing polymer precursors may comprise a sulfonyl fluoride or chloride group. A specific example of such an ion-containing polymer precursor that comprises a sulfonyl fluoride group is FSO₂—CF₂—CF₂—CF₂—CF₂—O-[polymer backbone]. Suitable ion-containing polymers or ion-containing polymer precursors may comprise polymers or blends of polymers having an equivalent weight of less than about 1200 and a glass transition temperature (Tg) of between about 80° C. and about 155° C. Suitable ion-containing polymers or ion-containing polymer precursors may have an equivalent weight of between about 700 and about 1200.

Details and further descriptions of suitable ion-containing polymers or ion-containing polymer precursors are disclosed in commonly owned U.S. Pat. Nos. 6,649,295 and 6,624,328; U.S. Published Application No. 20040121210; U.S. Ser. No. 10/697,768 filed Oct. 30, 2003; and U.S. Ser. No. 10/697,831 filed Oct. 30, 2003, all of which are hereby incorporated herein by reference.

A significant advantage of microwave annealing coated membranes according to the present invention involves the use of relatively inexpensive liners, in contrast to more costly liners needed for thermal annealing processes. The liners or carriers used in conventional thermal annealing processes must be fabricated from relatively expensive high temperature materials, and must withstand oven temperatures of up to 200° C., for example.

The liners or carriers used in connection with microwave annealing of the present invention, in contrast, can be formed from less expensive materials with much lower upper use temperatures. For example, a liner may have an upper use temperature about equal to or less than a film forming temperature associated with the membrane. Such a liner could not be used in a thermal annealing process. Such film forming temperatures (or glass transition temperatures) can be as low as about 80° C., and typically range between about 80° C. and 200° C. It is noted that, in certain processes, film forming temperatures can have an upper range of about 300° C. Suitable liners or carriers include those fabricated from polymeric materials, including, but not limited to, polyolefins, polyesters, polyethylenenaphthalates, polyimides, and fluoropolymers.

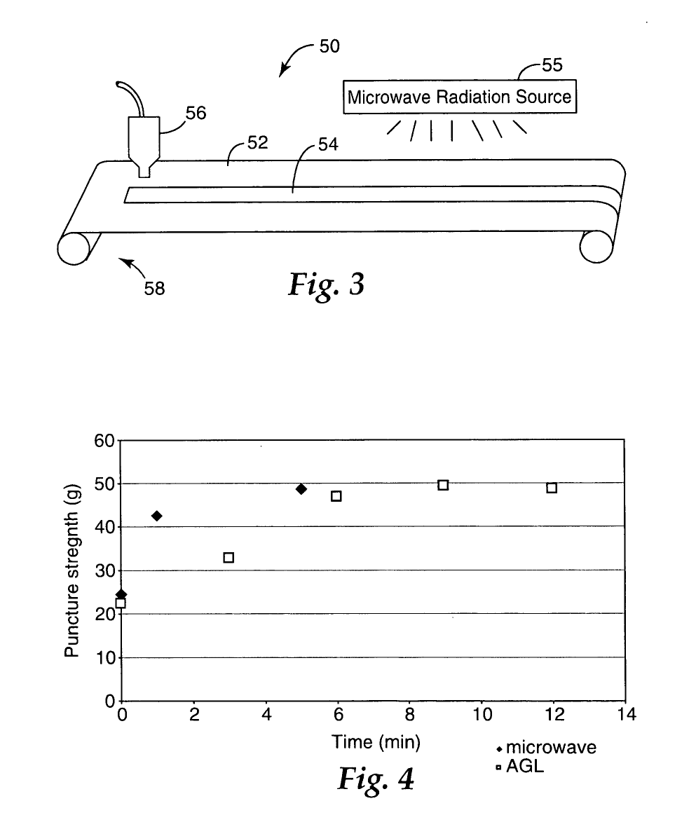

Turning now to FIG. 3, there is depicted an apparatus for manufacturing an ion-containing membrane for use in a membrane electrode assembly of a fuel cell in accordance with an embodiment of the present invention. The simplified illustration of FIG. 3 depicts a continuous membrane manufacturing process that is capable of mass producing a membrane for use in membrane electrode assemblies. The apparatus 50 includes a continuous roll good liner 52 that is driven by a drive apparatus 58. The apparatus 50 also includes a bar coater, spray coater, slit coater, brush coater, or other solution casting device 56. A release agent may be applied to the liner 52 prior dispensing of the solution or suspension onto the liner 52. The solution or suspension comprises an ion-containing polymer or ion-containing polymer precursor of a type previously described. The membrane 54 is transported by controller movement of the liner 52 under a microwave radiation source 55. The membrane 54 is transported under the microwave radiation source 55 and subject to microwave annealing. It is to be understood that the source of the microwave radiation could be in other orientations relative to the membrane (e.g., under the membrane). The microwave annealed membrane 54 is transported to the next station (not shown) for additional handling or processing.

The microwave radiation source 55 may be tuned in a variety of ways that facilitate efficient and effective microwave annealing of the membranes 54. For example, the microwave radiation source 55 may be tuned to preferentially excite a liquid component of the solution or suspension comprising an ion-containing polymer or ion-containing polymer precursor. By way of further example, the microwave radiation source 55 may be tuned to preferentially excite water in the solution or suspension. In another example, the microwave radiation source 55 may be tuned to preferentially excite functional groups of the polymer of the solution or suspension. In yet another example, the microwave radiation source 55 may be tuned to excite some feature of the liner or carrier upon which the cast membranes 54 are transported.

As was discussed briefly hereinabove, microwave annealing of a cast membrane according to the principles of the present invention has been shown to successfully produce membranes with good mechanical properties, including good puncture resistance, that are at least comparable with membranes fabricated using conventional thermal annealing processes, as is demonstrated in the following example and in FIG. 4.

### EXAMPLE

Membrane samples were prepared using a perfluoro ionomer copolymer produced from tetrafluoroethylene and a FSO₂—(CF₂)₄—O—CF═CF₂ monomer (MV-4S) having 980 equivalent weight. The MV-4S monomer preparation is described in commonly owned and previously incorporated U.S. Pat. No. 6,624,328. The polymer preparation is described in commonly owned published U.S. 20040121210. Preparation of the membrane samples involved coating and thermally annealing at 160° C. on a coater apparatus as described in commonly owned published U.S. 20040121210.

One set of membrane samples (indicated in FIG. 4 as the AGL data points) were thermally annealed off the liner on an oil-heated laminator at 200° C. Multiple passes of the same membrane gave different annealing times. Another set of membrane samples were microwave annealed off the liner in an Amana model # RFS9B microwave oven (Amana, division of Maytag Corporation, Newton, Iowa) for various times.

Puncture resistance values were measured using a 5 lb load cell and a 10 micron tip. The data were plotted in FIG. 4, which shows puncture resistance as a function of time for the laminator thermally annealed membrane (ALG data in FIG. 4) and the microwave annealed membrane (microwave data in FIG. 4). The data of FIG. 4 demonstrates similar or superior puncture resistance of membranes subject to microwave annealing in comparison to membranes subject to laminator (i.e., “hot can”) thermal annealing.

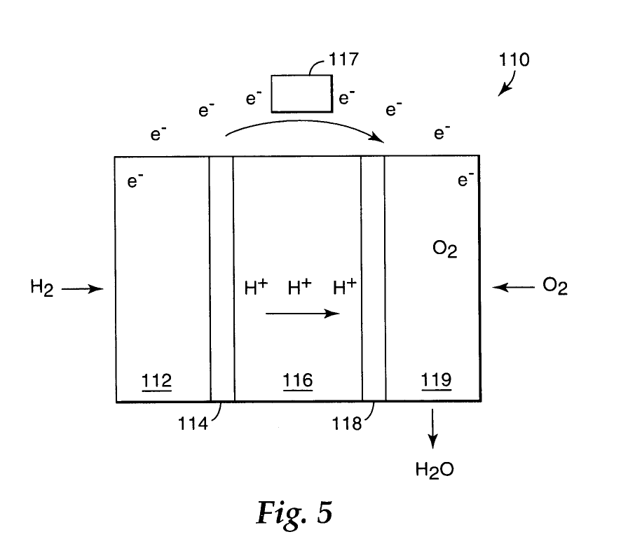

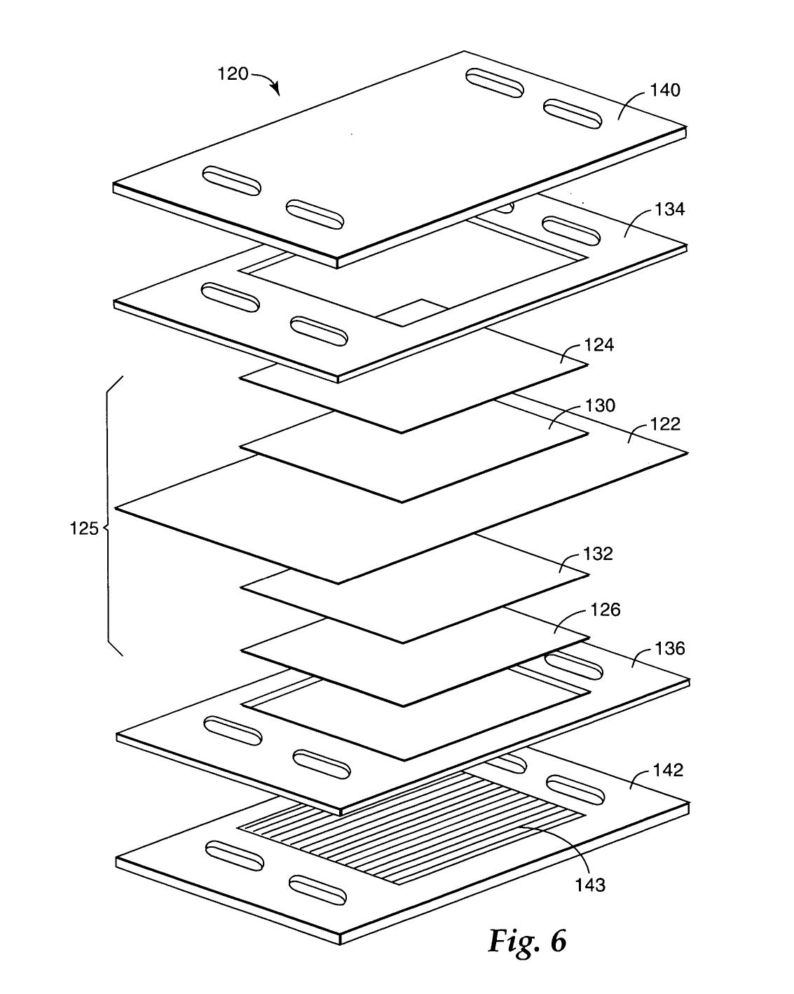

A membrane fabricated using microwave annealing in accordance with the present invention may be incorporated in fuel cell assemblies and stacks of varying types, configurations, and technologies. A typical fuel cell is depicted in FIG. 5. A fuel cell is an electrochemical device that combines hydrogen fuel and oxygen from the air to produce electricity, heat, and water. Fuel cells do not utilize combustion, and as such, fuel cells produce little if any hazardous effluents. Fuel cells convert hydrogen fuel and oxygen directly into electricity, and can be operated at much higher efficiencies than internal combustion engines, for example.

The fuel cell 110 shown in FIG. 5 includes a first diffuser/current collector (DCC) 112 adjacent an anode 114. Adjacent the anode 114 is an electrolyte membrane 116. A cathode 118 is situated adjacent the electrolyte membrane 116, and a second diffuser/current collector 119 is situated adjacent the cathode 118. In operation, hydrogen fuel is introduced into the anode portion of the fuel cell 110, passing through the first diffuser/current collector 112 and over the anode 114. At the anode 114, the hydrogen fuel is separated into hydrogen ions (H⁺) and electrons (e⁻).

The electrolyte membrane 116 permits only the hydrogen ions or protons to pass through the electrolyte membrane 116 to the cathode portion of the fuel cell 110. The electrons cannot pass through the electrolyte membrane 16 and, instead, flow through an external electrical circuit in the form of electric current. This current can power an electric load 117, such as an electric motor, or be directed to an energy storage device, such as a rechargeable battery.

The PEM used in a PEM fuel cell is typically a thin solid polymer electrolyte sheet that allows hydrogen ions to pass through it, but yet separates the gaseous reactants. The membrane is typically coated on both sides with highly dispersed metal or metal alloy particles (e.g., platinum or platinum/ruthenium) that are active catalysts. The membrane of the PEM is preferably formed from an ion-containing polymer manufactured with use of microwave annealing in accordance with the principles of the present invention. The MEA is the central element of PEM fuel cells, such as hydrogen fuel cells. As discussed above, typical MEAs comprise a polymer electrolyte membrane (PEM) (also known as an ion conductive membrane (ICM)), which functions as a solid electrolyte.

Oxygen flows into the cathode side of the fuel cell 110 via the second diffuser/current collector 119. As the oxygen passes over the cathode 118, oxygen, protons, and electrons combine to produce water and heat.

The DCC may also be called a gas diffusion layer (GDL). The anode and cathode electrode layers may be applied to the PEM or to the DCC during manufacture, so long as they are disposed between the PEM and DCC in the completed MEA. Useful PEM thicknesses range between about 200 μm and about 15 μm. The PEM preferably incorporates an ion-containing polymer membrane of a type described hereinabove.

Any suitable DCC may be used in the practice of the present invention. Typically, the DCC is comprised of sheet material comprising carbon fibers. The DCC is typically a carbon fiber construction selected from woven and non-woven carbon fiber constructions. Carbon fiber constructions which may be useful in the practice of the present invention may include: Toray Carbon Paper, SpectraCarb Carbon Paper, AFN non-woven carbon cloth, Zoltek Carbon Cloth, and the like. The DCC may be coated or impregnated with various materials, including carbon particle coatings, hydrophilizing treatments, and hydrophobizing treatments such as coating with polytetrafluoroethylene (PTFE).

Any suitable catalyst may be used in the practice of the present invention, including platinum blacks or fines, ink containing carbon-supported catalyst particles (as described in U.S. 20040107869 and herein incorporated by reference), or nanostructured thin film catalysts (as described in U.S. Pat. No. 6,482,763 and U.S. Pat. No. 5,879,827, both incorporated herein by reference). The catalyst may be applied to the PEM or the DCC by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

Individual fuel cells, such as that shown in FIG. 5, can be packaged as unitized fuel cell assemblies. The unitized fuel cell assemblies, referred to herein as unitized cell assemblies (UCAs), can be combined with a number of other UCAs to form a fuel cell stack. The UCAs may be electrically connected in series with the number of UCAs within the stack determining the total voltage of the stack, and the active surface area of each of the cells determines the total current. The total electrical power generated by a given fuel cell stack can be determined by multiplying the total stack voltage by total current.

A UCA packaging methodology of the present invention can be employed to construct PEM fuel cell assemblies. PEM fuel cells have high power density, can vary their output quickly to meet shifts in power demand, and are well suited for applications where quick startup is required, such as in automobiles.

Referring now to FIG. 6, there is illustrated an embodiment of a UCA implemented in accordance with a PEM fuel cell technology that incorporates an ion-containing polymer membrane of a type described hereinabove. As is shown in FIG. 6, an MEA 125 of the UCA 120 includes five component layers. A PEM layer 122 is sandwiched between DCC layers 124 and 126, or gas diffusion layers (GDLs) for example. An anode catalyst 130 is situated between a first DCC 124 and the ion-containing polymer membrane 122, and a cathode catalyst 132 is situated between the membrane 122 and a second DCC 126.

In one configuration, a PEM layer 122 is fabricated to include an anode catalyst coating 130 on one surface and a cathode catalyst coating 132 on the other surface. This structure is often referred to as a catalyst-coated membrane or CCM. According to another configuration, the first and second DCCs 124, 126 are fabricated to include an anode and cathode catalyst coating 130, 132, respectively.

The DCCs 124, 126 are typically fabricated from a carbon fiber paper or non-woven material or woven cloth. Depending on the product construction, the DCCs 124, 126 can have carbon particle coatings on one side. The DCCs 124, 126, as discussed above, can be fabricated to include or exclude a catalyst coating.

In the particular embodiment shown in FIG. 6, MEA 125 is shown sandwiched between a first edge seal system 134 and a second edge seal system 136. The edge seal systems 134, 136 provide the necessary sealing within the UCA package to isolate the various fluid (gas/liquid) transport and reaction regions from contaminating one another and from inappropriately exiting the UCA 120, and may further provide for electrical isolation and hard stop compression control between flow field plates 140, 142.

Flow field plates 140 and 142 are positioned adjacent the first and second edge seal systems 134 and 136, respectively. Each of the flow field plates 140, 142 includes a field of gas flow channels 143 and ports through which hydrogen and oxygen feed fuels pass. The flow field plates 140, 142 may also incorporate coolant channels and ports. The coolant channels are incorporated on surfaces of the flow field plates 140, 142 opposite the surfaces incorporating the gas flow channels 143.

In the configuration depicted in FIG. 6, flow field plates 140, 142 are configured as monopolar flow field plates, in which a single MEA 125 is sandwiched there between. The flow field in this and other embodiments may be a low lateral flux flow field as disclosed in commonly owned U.S. Published Application No. U.S.20030059662, which is incorporated herein by reference. It is understood that UCAs or multi-cell assembly (MCAs) may be implemented to incorporate multiple MEAs 125 through employment of one or more bipolar flow field plates. Such UCAs or MCAs may incorporate a bipolar flow field plate which incorporates integral cooling channels.

The configurations shown in FIGS. 5 and 6 are representative of two particular arrangements that can be implemented for use in the context of a fuel cell assemblies that incorporate ion-containing polymer membranes fabricated using microwave annealing in accordance with the present invention. These two arrangements are provided for illustrative purposes only, and are not intended to represent all possible configurations coming within the scope of the present invention.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What we claim is:

1. A method of manufacturing a film, comprising:
providing a coating comprising an ion-containing polymer or ion-containing polymer precursor; and
microwave annealing the coating.

2. The method according to claim 1, wherein annealing the coating comprises subjecting the coating to the microwave radiation for a duration of time sufficient for the coating to reach or exceed a film forming temperature.

3. The method according to claim 1, wherein microwave annealing the coating comprises subjecting the coating to microwave radiation that preferentially excites a liquid component of the coating.

4. The method according to claim 1, wherein microwave annealing the coating comprises subjecting the coating to microwave radiation that preferentially excites water in the coating.

5. The method according to claim 1, wherein microwave annealing the coating comprises subjecting the coating to microwave radiation that preferentially excites functional groups of the polymer of the coating.

6. The method according to claim 1, further comprising providing the coating on a liner, and microwave annealing the coating to form the film on the liner.

7. The method according to claim 1, wherein the ion-containing polymer or ion-containing polymer precursor comprises an aromatic polymer.

8. The method according to claim 1, wherein the ion-containing polymer or ion-containing polymer precursor comprises a fluoropolymer.

9. The method according to claim 1, wherein the ion-containing polymer or ion-containing polymer precursor comprises a fluoropolymer bearing sulfonate functional groups.

10. The method according to claim 1, wherein the ion-containing polymer or ion-containing polymer precursor comprises a fluoropolymer derived from a fluoropolymer latex.

11. The method according to claim 1, further comprising thermally annealing the ion-containing polymer or ion-containing polymer precursor.

12. The method according to claim 1, further comprising drying the coating.

13. A method of manufacturing an ion-containing membrane for use in a membrane electrode assembly of a fuel cell, comprising:
coating a solution or suspension of an ion-containing polymer or ion-containing polymer precursor to form a membrane of the membrane electrode assembly; and
microwave annealing the membrane.

14. The method according to claim 13, wherein the membrane comprises a proton exchange membrane.

15. The method according to claim 13, wherein microwave annealing the membrane comprises subjecting the membrane to the microwave radiation for a duration of time sufficient for the coating to reach or exceed a film forming temperature.

16. The method according to claim 13, wherein microwave annealing the membrane comprises subjecting the cast membrane to microwave radiation that preferentially excites a liquid component of the solution.

17. The method according to claim 13, wherein microwave annealing the cast membrane comprises subjecting the cast membrane to microwave radiation that preferentially excites water in the solution.

18. The method according to claim 13, wherein microwave annealing the cast membrane comprises subjecting the cast membrane to microwave radiation that preferentially excites functional groups of the polymer of the solution.

19. The method according to claim 13, wherein microwave annealing the cast membrane comprises microwave annealing the cast membrane in accordance with a continuous manufacturing process.

20. The method according to claim 13, wherein:
coating the solution or suspension comprises coating the solution on a liner; and
microwave annealing the cast membrane comprises microwave annealing the cast membrane with the cast membrane on the liner.

21. A membrane electrode assembly comprising the membrane produced by the method of claim 13.

22. A fuel cell comprising a membrane electrode assembly, the membrane of the membrane electrode assembly produced by the method of claim 13.

23. A sub-assembly for use in manufacturing a membrane electrode assembly of a fuel cell, comprising:
a membrane comprising an ion-containing polymer; and
a liner in contact with the membrane, the liner having an upper use temperature about equal to or less than a film forming temperature associated with the membrane.

24. The sub-assembly of claim 23, wherein the membrane comprises a proton exchange membrane.

25. The sub-assembly of claim 23, wherein the liner comprises a polyolefin.

26. The sub-assembly of claim 23, wherein the liner is formed from a material selected from the group consisting of polyesters, polyethylenenaphthalates, polyimides, and fluoropolymers.

27. The sub-assembly of claim 23, wherein the film forming temperature ranges from about 80° C. to about 300° C.
